(19) United States
(12) Patent Application Publication
(10) Pub. No.: US 2025/0001328 A1
(43) Pub. Date: Jan. 2, 2025

(54) FLUIDIC DEVICE

(71) Applicant: SEIKO EPSON CORPORATION, TOKYO (JP)

(72) Inventors: Keita KUBO, Matsumoto-shi (JP); Chikara KOJIMA, Matsumoto-shi (JP); Hiroto TOMIOKA, SHIOJIRI-SHI (JP); Yoshio ARAI, Shiojiri-shi (JP)

(21) Appl. No.: 18/759,839

(22) Filed: Jun. 29, 2024

(30) Foreign Application Priority Data
Jun. 30, 2023 (JP) 2023-107976

(51) Int. Cl. B01D 21/28; C02F 1/36

(52) U.S. Cl. CPC B01D 21/283; C02F 1/36

(57) ABSTRACT

A fluidic device that uses ultrasonic waves to trap microparticles contained in a fluid, the fluidic device includes: a body having a flow path through which the fluid flows and an ultrasonic element provided on a flow path wall forming the flow path of the body and configured to transmit ultrasonic waves in first direction to form a standing wave in the flow path, wherein the body has, with a portion where the ultrasonic element is arranged as a trapping section, an inflow section configured to cause the fluid to flow into the trapping section along a second direction intersects with the first direction, a first outflow section through which concentrated fluid containing microparticles trapped by the standing wave flows out from the trapping section, and a second outflow section through which diluted fluid having a concentration of the microparticles lower than that of the concentrated fluid flows out from the trapping section, the inflow section is provided at a negative side of the trapping section in the second direction, the first outflow section is provided at a positive side of the trapping section in the second direction, and the second outflow section is provided at the negative side of the trapping section in the second direction at a position different from that of the inflow section.

The present application is based on, and claims priority from JP Application Serial Number 2023-107976, filed Jun. 30, 2023, the disclosure of which is hereby incorporated by reference herein in its entirety.

### BACKGROUND

### 1. Technical Field

The present disclosure relates to a fluidic device.

### 2. Related Art

In the related art, a fluidic device that acoustically focuses microparticles in a fluid is known. For example, the device described in “ULTRASONIC SEPARATION OF SUSPENDED PARTICLES” E. Benes et al., Reprint Proc. of the 2001 IEEE International Ultrasonics Symposium, a Joint Meeting with the World Congress on Ultrasonics, Atlanta, Georgia, USA, Oct. 7-10, 2001, p649-659 transmits ultrasonic waves from an ultrasonic element into a flow path to form a standing wave. As a result, the microparticles contained in the fluid flowing through the flow path are trapped at the positions of the nodes of the standing wave by the pressure gradient of the standing wave. The trapped microparticles flow to one outlet (concentrated fluid outlet) of the flow path, and the diluted fluid flows to the other outlet (diluted fluid outlet).

However, in the fluidic devise disclosed in “ULTRASONIC SEPARATION OF SUSPENDED PARTICLES”, a fluid inlet is provided on one side (the −X side) of the fluidic device, and both a concentrated fluid outlet and a diluted fluid outlet are provided on the other side (the +X side). In this case, the fluid flowing into the fluidic device from the fluid inflow port toward the +X side has a large velocity component not only in the X direction but also in the Z direction orthogonal to the X direction, that is, in the direction in which the standing wave is formed by the ultrasonic element. Here, as the force related to the microparticles in the fluid, when the force due to the velocity component in the Z direction is larger than the force due to the acoustic radiation force of the standing wave, the number of microparticles trapped at the node of the standing wave moves against the acoustic radiation force, and the number of microparticles flowing out from the diluted fluid outlet increases. Therefore, in the fluidic device of the related art, it is necessary to further connect another fluid device to the dilution fluid outlet to form a multistage configuration and improve the trapping efficiency of the microparticles. Therefore, the cost and size of the apparatus increase.

### SUMMARY

In the first aspect of the present disclosure, a fluidic device that uses ultrasonic waves to trap microparticles contained in a fluid, the fluidic device includes: a body having a flow path through which the fluid flows and an ultrasonic element provided on a flow path wall forming the flow path of the body and configured to transmit ultrasonic waves in a first direction to form a standing wave in the flow path, wherein the body has, with a portion where the ultrasonic element is arranged as a trapping section, an inflow section configured to cause the fluid to flow into the trapping section along a second direction, which intersects the first direction, a first outflow section through which concentrated fluid containing microparticles trapped by the standing wave flows out from the trapping section, and a second outflow section through which diluted fluid having a concentration of the microparticles lower than that of the concentrated fluid flows out from the trapping section, the inflow section is provided at a negative side of the trapping section in the second direction, the first outflow section is provided at a positive side of the trapping section in the second direction, and the second outflow section is provided at the negative side of the trapping section in the second direction at a position different from that of the inflow section.

### BRIEF DESCRIPTION OF THE DRAWINGS

FIG. 1 is a cross-sectional view schematically showing a fluidic device according to a first embodiment and a flow of microparticles and a fluid in the fluidic device.

FIG. 2 is a perspective view showing a body of the fluidic device of the first embodiment.

FIG. 3 is a trihedral drawing of the body of the fluidic device of the first embodiment.

FIG. 4 is a cross-sectional view of the body taken along line A-A of FIG. 3.

FIG. 5 is a schematic cross-sectional view showing an example of the ultrasonic applying section of the first embodiment.

FIG. 6 is a diagram showing a flow velocity and a flow direction of a fluid flowing through the fluidic device of the first embodiment.

FIG. 7 is a graph showing the Z component of the flow velocity at each X-coordinate position of line B-B in FIG. 6.

FIG. 8 is a graph showing X component of the flow velocity at each X-coordinate position on the line B-B in FIG. 6.

FIG. 9 is a diagram showing an outline of a fluidic device of a comparative example and flow of fluid.

FIG. 10 is a perspective view showing a fluidic device of a second embodiment.

FIG. 11 is a perspective view showing a body of a fluidic device according to a first modification.

FIG. 12 shows the distribution of the flow velocity and direction of the fluid when it flows into the body of the fluidic device of the first modification.

FIG. 13 is a graph showing the Z component of the flow velocity on an extension in the X direction of an inflow section of a fluidic device of first modification.

FIG. 14 is a perspective view showing a body of a fluidic device according to a second modification.

FIG. 15 is a perspective view showing a body of a fluidic device according to the second modification.

FIG. 16 is a perspective view showing a body of a fluidic device of the second modification.

### DESCRIPTION OF EMBODIMENTS

### First Embodiment

Hereinafter, the fluidic device according to the first embodiment will be described.

### Configuration of the Fluidic Device

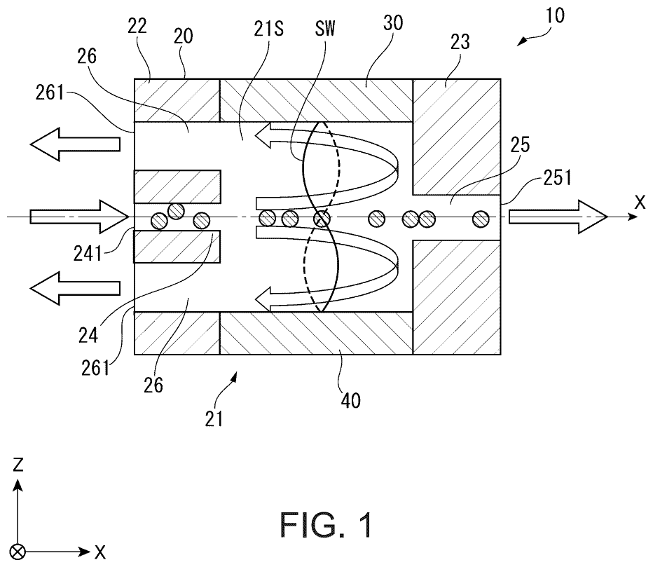

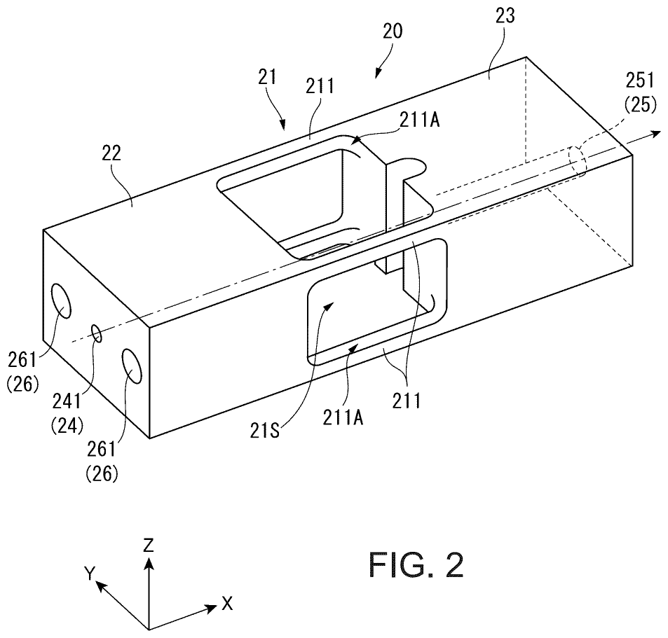

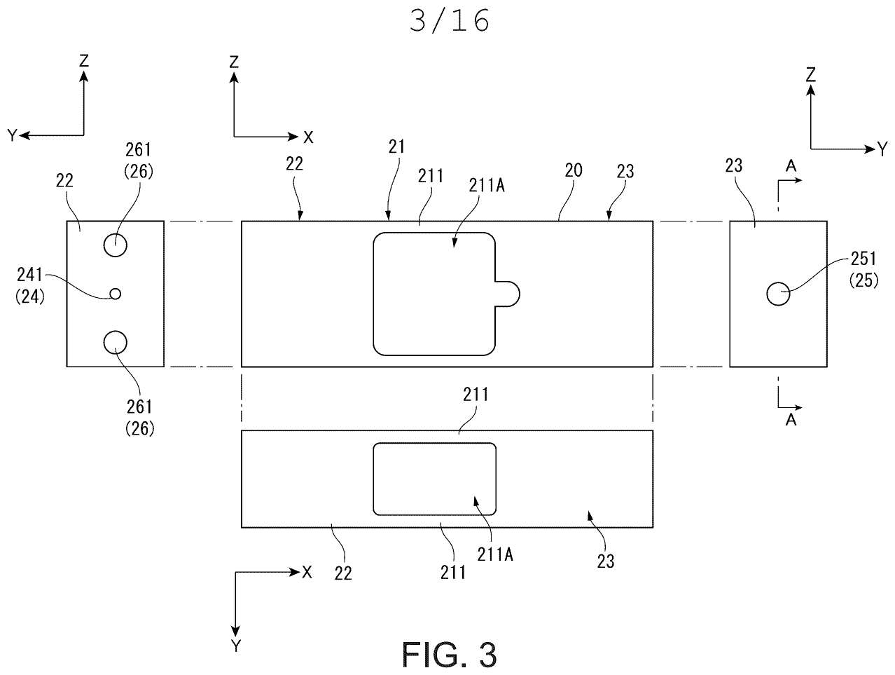

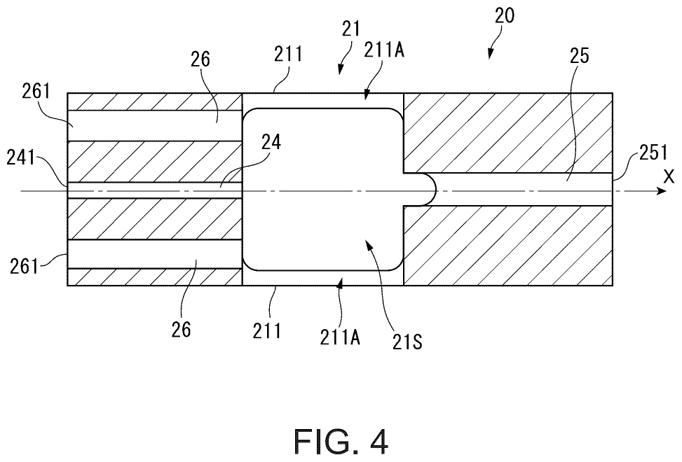

FIG. 1 is a cross-sectional view schematically showing a fluidic device 10 according to the first embodiment and the flow of microparticles and a fluid in the fluidic device 10. FIG. 2 is a perspective view showing only a body 20 of the fluidic device 10, FIG. 3 is a trihedral drawing (front view, plan view, and side view) of the body 20, and FIG. 4 is a cross-sectional view of the body 20 taken along line A-A of FIG. 3.

The fluidic device 10 includes the block-shaped body 20, an ultrasonic applying section 30 (ultrasonic element) fixed to the body 20, and flow path wall sections 40 fixed to the body 20.

As shown in FIGS. 2 to 4, the body 20 includes a center section 21, a negative side wall section 22 provided on one side of the center section 21, and a positive side wall section 23 provided on the other side of the center section 21. Here, a direction from the negative side wall section 22 toward the positive side wall section 23 is defined as an X direction, a direction intersecting (in this example, orthogonal to) the X direction is defined as a Z direction, and a direction intersecting (in this example, orthogonal to) the X and Z directions is defined as a Y direction. An axis which passes through a center point (centroid point) when the center section 21 is cut along the ZY plane and is parallel to the X direction is set as an X axis. Note that in the Z direction corresponds to the first direction according to the present disclosure, the X direction corresponds to the second direction, and the Y direction corresponds to the third direction.

The center section 21 of the body 20 is constituted by four bridging sections 211 that couple the surface of the negative side wall section 22 on the +X side and the surface of the positive side wall section 23 on the −X side. Specifically, surfaces (surfaces orthogonal to the X-axis) of the negative side wall section 22 and of the positive side wall section 23 that face each other have a substantially rectangular shape, and four bridging sections 211 are provided so as to bridge corner portions of the rectangles. The bridging sections 211, the negative side wall section 22, and the positive side wall section 23 form opening sections 211A in the center section 21 at positions facing each other in the Y direction and at positions facing each other in the Z direction. The ultrasonic applying section 30 or a flow path wall section 40 is disposed in each opening section 211A. For example, in the present embodiment, the ultrasonic applying section 30 is located on the +Z side of the center section 21 to close the opening section 211A on the +Z side, and the flow path wall section 40 that is parallel to the ultrasonic applying section 30 is located on the −Z side of the center section 21 to close the opening section 211A on the −Z side. Flow path wall sections 40 are located in both opening sections 211A on the +Y sides of the center section 21 to close the opening sections 211A.

Further, the negative side wall section 22 and the positive side wall section 23 located with the center section 21 of the body 20 interposed therebetween have wall surfaces orthogonal to the X axis and face each other. Therefore, the center section 21 is surrounded by one ultrasonic applying section 30, three flow path wall sections 40, the wall surface of the negative side wall section 22 on the +X side, and the wall surface of the positive side wall section 23 on the −X side. Thus, a space with a shape is formed that is rectangular in cross-sectional view of the YZ plane. This space serves as a trapping section 21S constituting a part of a flow path into which fluid is introduced. As will be described in detail later, microparticles in the fluid flowing through the trapping section 21S are trapped by a standing wave SW (see FIG. 1) formed by the ultrasonic waves transmitted from the ultrasonic applying section 30.

Note that although the present embodiment exemplifies a configuration in which the flow path wall sections 40, which are members separate from body 20, are provided on the three opening sections 211A of the body 20, the flow path wall sections 40 may be integrally configured with the body 20. That is, a configuration may be adopted in which the opening sections 211A are not formed, and walls corresponding to the flow path wall sections 40 are provided between the bridging sections 211 in the center section 21 so as to be continuous with the bridging sections 211.

The ultrasonic applying section 30 is not particularly limited as long as it is a device capable of forming a standing wave by transmitting ultrasonic waves to the trapping section 21S. For example, a bulk-type ultrasonic apparatus that transmits ultrasonic waves by vibrating a piezoelectric body itself may be used, or a thin-type ultrasonic apparatus Micromachined Ultrasonic Transducer (MUT) that transmits ultrasonic waves by vibrating a diaphragm may be used. To promote miniaturization of the fluidic device 10, it is desirable to use a MUT, and it is more desirable to use a Piezoelectric Micromachined Ultrasonic Transducer (pMUT) in which the power consumption for outputting ultrasonic waves is small.

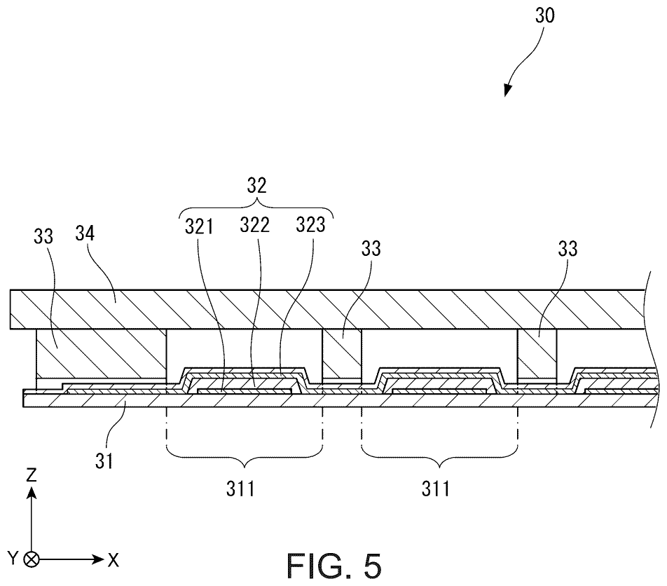

FIG. 5 is a schematic cross-sectional view showing an example of the ultrasonic applying section 30 of the present embodiment.

For example, in the present embodiment, a pMUT is used as the ultrasonic applying section 30. Specifically, as shown in FIG. 5, the ultrasonic applying section 30 includes a diaphragm 31, a piezoelectric element 32, a suppression section 33, and a reinforcement plate 34.

The diaphragm 31 includes a flat first substrate formed of, for example, Si, and a flat second substrate stacked on the +Z side of the first substrate and formed of, for example, SiO₂ and metallic oxides such as ZrO₂. The −Z side surface of the diaphragm 31 serves as an ultrasound transmission surface facing the trapping section 21S.

The piezoelectric element 32 is located on the +Z side (on the second substrate) of the diaphragm 31, and is configured by stacking a first electrode 321, a piezoelectric layer 322, and a second electrode 323 in the Z direction. The piezoelectric layer 322 is made of, for example, a perovskite-type transition metal oxide containing Pb, and is PZT containing Pb, Zr, and Ti in this embodiment.

The suppression section 33 is a member provided on the +Z side of the diaphragm 31, and is formed of, for example, a permanent resist. Specifically, the suppression section 33 is formed in a frame shape surrounding the outer periphery of the piezoelectric element 32 when viewed from the Z direction. The other end of the suppression section 33 on the side opposite to the diaphragm 31 is coupled to the reinforcement plate 34 to suppress the vibration of the diaphragm 31. Thus, a vibration region (oscillation section 311) of the diaphragm 31 vibrated by the piezoelectric element 32 is defined. That is, in the present embodiment, an ultrasonic wave is output by the oscillation section 311, which of the diaphragm 31, is that surrounded by the suppression section 33, vibrating.

The reinforcement plate 34 has a sufficiently larger thickness in the Z direction than the diaphragm 31, and it is bonded to the diaphragm 31 via the suppression section 33. Therefore, it reinforces the diaphragm 31 and prevents the suppression section 33 from vibrating together with the diaphragm 31.

By applying a periodic drive voltage between the first electrode 321 and the second electrode 323 in the ultrasonic applying section 30, the oscillation section 311 of the diaphragm 31 vibrates, and an ultrasonic wave is transmitted to the −Z side.

Note that in the example of FIG. 5, the diaphragm 31 is partitioned by the suppression section 33 to form the oscillation section 311, but it is not limited to this. For example, a separate substrate may be bonded to the −Z side (the transmitter side of the ultrasonic wave) of the diaphragm 31, and an opening window that defines the oscillation section 311 may be formed in the substrate.

Returning to FIGS. 1 to 4, the flow path wall sections 40 are plate-shaped members that form the trapping section 21S and are provided on the opening sections 211A on the −Z side and on the +Y side of the center section 21 of the body 20. The materials of the respective flow path wall sections 40 may be different from each other, but at least the flow path wall section 40 disposed at a position facing the ultrasonic applying section 30 is formed of a material that reflects an ultrasonic wave.

In the present embodiment, the relationship between the distance L_{Z} between the ultrasonic applying section 30 and the flow path wall section 40 facing the ultrasonic applying section 30 in the Z direction and the wavelengths of the ultrasonic wave λ is L_{Z}=nλ/2, n being an integer of two or more. The distance L_{Z} may be appropriately set according to the wavelengths λ of the ultrasonic waves that can be output by the ultrasonic applying section 30, and the wavelength (frequency) of the ultrasonic waves of the ultrasonic applying section 30 may be adjusted according to the distance L_{Z}.

Note that as described above, the flow path wall sections 40 may be formed integrally with the body 20.

In such a configuration, when ultrasonic waves are transmitted from the ultrasonic applying section 30 to the fluid in the trapping section 21S, a standing wave SW (see FIG. 1) is formed between the ultrasonic transmission surface of the ultrasonic applying section 30 and the flow path wall section 40 facing the ultrasonic applying section 30.

Note that in FIG. 1, the standing wave SW is shown at a partial position in the X direction, but in the present embodiment, the ultrasonic transmission surface of the ultrasonic applying section 30 is the entire surface on the +Z side of the trapping section 21S, and the standing wave SW is formed in the entire region of the trapping section 21S. In the present embodiment, for simplification of description, an example in which the standing wave SW of the first-order mode is formed by the ultrasonic applying section 30. However, the standing wave SW may be a standing wave SW of a higher order mode (a standing wave SW in which a plurality of positions of nodes is provided).

In the fluidic device 10 of the present embodiment, the body 20 includes an inflow section 24, a first outflow section 25, and second outflow sections 26 that communicate with the trapping section 21S.

The inflow section 24 and the second outflow sections 26 are provided in the negative side wall section 22 of the body 20 and communicate with the trapping section 21S. The first outflow section 25 is provided in the positive side wall section 23 of the body 20 and communicates with the trapping section 21S.

In particular, the inflow section 24 is a fluid introduction port for introducing fluid containing microparticles into trapping section 21S. In the present embodiment, the inflow section 24 is formed in the negative side wall section 22 such that the center of the inflow section 24 coincides with the center of the trapping section 21S when the body 20 is viewed along the X axis. That is, in the present embodiment, the inflow central axis of the inflow section 24 provided parallel to the X direction coincides with the X axis.

In the present embodiment, the cross section of the inflow section 24 (the cross section cut along the YZ plane) has a circular shape, and its bore diameter W1 is smaller than the bore diameter W2 of the first outflow section 25 and the bore diameter W3 of the second outflow sections 26.

In the present embodiment, the inflow section 24 has a flow path extending parallel to the X axis from the trapping section 21S to the −X side end surface of the negative side wall section 22, and an inflow tube (not shown) for sending fluid to the fluidic device 10 is connected to an inflow coupling section 241 (see FIGS. 3 and 4) at the −X side end portion.

The first outflow section 25 is provided on the +X side of the trapping section 21S, that is, in the positive side wall section 23, and communicates with the trapping section 21S. The first outflow section 25 is provided at a position facing to the inflow section 24 with the trapping section 21S interposed therebetween and at a position overlapping with a node of the standing wave SW when viewed from the X direction.

For example, in the present embodiment, as shown in FIG. 1, the standing wave SW of the first order mode is formed by the ultrasonic applying section 30. In this case, there is one node position, and the node appears at the center of the trapping section 21S in the Z direction. Therefore, when viewed from the X direction, the first outflow section 25 is disposed at a position overlapping the center of the trapping section 21S or the inflow section 24, that is, on the X axis.

The bore diameter W2 of the first outflow section 25 is larger than the bore diameter W1 of the inflow section 24 and smaller than the bore diameter W3 of the second outflow sections 26. If the bore diameter W2 of the first outflow section 25 were smaller than the bore diameter W1 of the inflow section 24, the concentrated fluid would not appropriately flow out from the first outflow section 25, and the microparticle concentration of the fluid flowing out from the second outflow sections 26 would become high. If the bore diameter W2 of the first outflow section 25 were larger than the bore diameter W3 of the second outflow sections 26, then the amount of the fluid flowing out from the first outflow section 25 would also increase, and the microparticle concentration of the fluid flowing out from the first outflow section 25 would decrease. In contrast, by satisfying W3>W2>W1 as described above, it is possible to appropriately cause the fluid containing many microparticles trapped at the position of the node of the standing wave SW in the trapping section 21S, that is, concentrated fluid having a high microparticle concentration, to flow out from the first outflow section 25.

In the present embodiment, the first outflow section 25 has a flow path extending parallel to the X axis from the trapping section 21S to the +X side end surface of the positive side wall section 23, and a first outflow tube (not shown) for sending out the concentrated fluid from the fluidic device 10 is coupled to a first outflow coupling section 251 (see FIGS. 3 and 4) at the +X side end portion. Thus, a concentrated fluid containing many microparticles (having a high concentration) can be recovered from the fluidic device 10.

The second outflow sections 26 are provided at the −X side of the trapping section 21S, that is, in the negative side wall section 22, and communicate with the trapping section 21S. It is desirable that a plurality of the second outflow sections 26 is provided and are provided at positions symmetrical with respect to the inflow section 24. For example, in the present embodiment, two second outflow sections 26 are provided, one second outflow section 26 is positioned on the +Z side of the inflow section 24, and another second outflow section 26 is positioned on the −Z side of the inflow section 24. Therefore, they are provided at positions point symmetrical with respect to the center (X-axis) of the inflow section 24. In other words, in the XZ plane passing through the X axis, the pair of second outflow sections 26 is line symmetric with respect to the X axis, and in the YZ plane orthogonal to the X axis, the pair of second outflow sections 26 is line symmetric with respect to a virtual line passing through the X axis and parallel to the Y direction. With such a configuration, the flow velocity distribution of the fluid on the +Z side and the −Z side of the trapping section 21S is symmetrical with respect to the X axis. The Z direction is a direction in which the standing wave SW is formed, and the flow velocity distribution is symmetrical on both +Z sides with respect to the X-axis, so that an imbalance of the Z component of the flow velocity does not occur. Thus, an increase in the Z component of the flow velocity can be suppressed.

As described above, the bore diameter W3 of the second outflow sections 26 is larger than the bore diameter W1 of the inflow section 24. If the bore diameter W3 of the second outflow sections 26 were smaller than the bore diameter W1 of the inflow section 24, the dilution fluid would not appropriately flow out from the second outflow sections 26, and the flow rate of the first outflow section 25 would increase. In this case, the microparticle concentration of the fluid flowing out from the first outflow section 25 would decrease. If the bore diameter W3 of the second outflow sections 26 were smaller than the bore diameter W1 of the inflow section 24, the flow velocity in the second outflow sections 26 would increase. Thus, there is a risk that the Z component of the flow velocity would also increase. On the other hand, when W3>W1 is satisfied, the flow rate and flow velocity of the fluid flowing out from the second outflow sections 26 can be appropriately controlled, and the concentration of the concentrated fluid flowing out from the first outflow section 25 can be increased.

In the present embodiment, the second outflow sections 26 have flow paths extending parallel to the X axis from the trapping section 21S to the −X side end surface of the negative side wall section 22, and second outflow tubed (not shown), which send out dilution fluid from the fluidic device 10, are coupled to second outflow coupling sections 261 (see FIGS. 3 and 4) at the −X side end portion. As a result, diluted fluid with fewer microparticles (low concentration) can be recovered from the fluidic device 10.

### Relationship in Fluidic Device Between Flow Velocity and Trapping of Microparticles

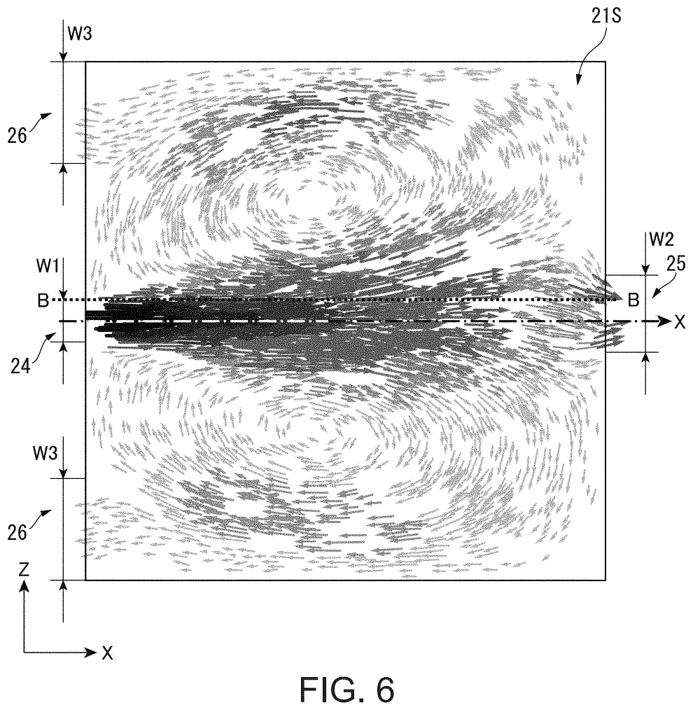

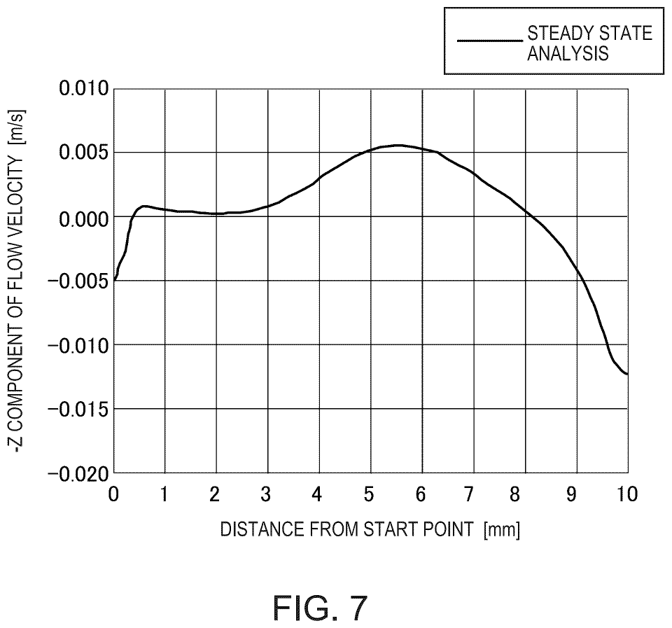

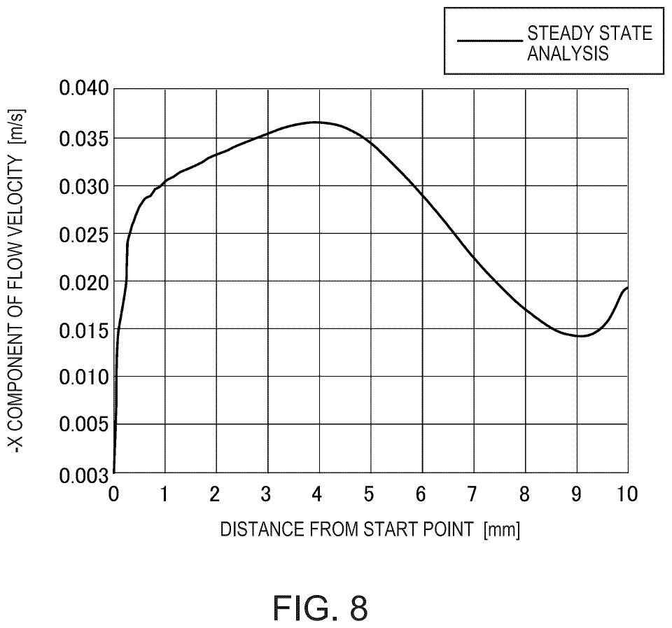

FIG. 6 shows the flow velocity and flow direction of the fluid flowing through the fluidic device 10 of the present embodiment. FIG. 7 is a graph showing the Z component of the flow velocity at each X coordinate position on the line B-B in FIG. 6. FIG. 8 is a graph showing the X component of the flow velocity (the flow velocity X component) at each X coordinate position on the line B-B in FIG. 6.

Note that FIGS. 7 and 8 show simulation results when the length L of the trapping section 21S in the X direction (length from the negative side wall section 22 to the positive side wall section 23) is L=10 mm, the bore diameter W1 of the inflow section 24 is W1=1.2 mm, the bore diameter W2 of the first outflow section 25 is W2=1.8 mm, the bore diameter W3 of the second outflow sections 26 is W3=2.0 mm, the velocity of the fluid in the inflow section 24 is 0.015 m/s, and the first outflow section 25 and the second outflow sections 26 are opened to the atmosphere.

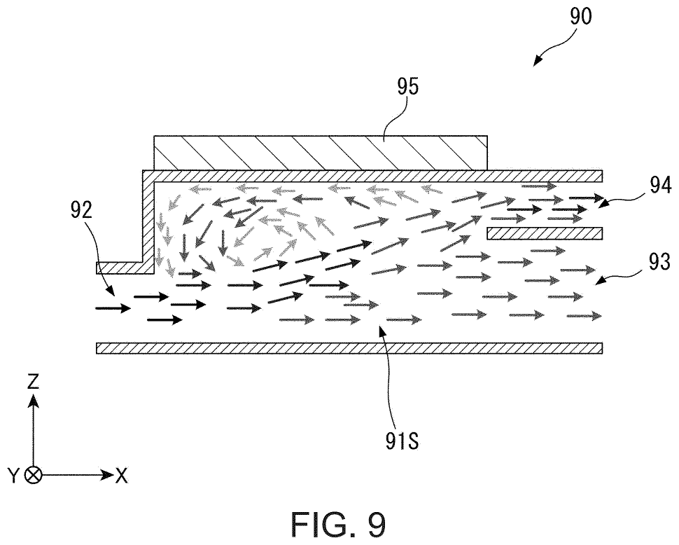

FIG. 9 is a diagram showing the flow velocity in the fluidic device of a comparative example.

In a fluidic device 90 of the comparative example of FIG. 9, an inflow section 92 is provided at the −X side and −Z side end portion of a trapping section 91S, a first outflow section 93 (outflow section for recovering the concentrated fluid) is provided at the +X side and −Z side end portion of the trapping section 91S, and a second outflow section 94 (outflow portion for recovering the diluted fluid) is provided at the +X side and +Z side end portion of the trapping section 91S. An ultrasonic applying section 95 is provided on the +Z side of the trapping section 91S and forms a standing wave of a high-order mode along the Z direction in the trapping section 91S.

In the fluidic device 10 of the present embodiment, the fluid flows from the inflow section 24 having a small bore diameter into the trapping section 21S which is suddenly much larger in bore diameter. Therefore, when viewed in the XZ cross-sectional view as shown in FIG. 6, the fluid generates vortices on the +Z side and on the −Z side of the trapping section 21S, and the trapping section 21S is caused to be filled with fluid.

More specifically, in the present embodiment, only the first outflow section 25 along the X axis is provided in the positive side wall section 23, and the other outflow ports are not provided in the positive side wall section 23. On the other hand, in the negative side wall section 22, the second outflow sections 26 are provided on the +Z sides of the inflow section 24. In the present embodiment, in the XZ cross-sectional view passing through the X axis, the centers of the vortices s appear at positions that are substantially symmetrical with respect to the X axis at substantially the center of the trapping section 21S in the X direction. Then, on the +Z side of the center of the vortex at the +Z side of the trapping section 21S, or on the −Z side of the center of the vortex at the −Z side of the trapping section 21S, the fluid flows toward the second outflow sections 26 provided on the −X side.

As a result, as shown in FIG. 6, in the fluid flowing in from the inflow section 24 along the X axis, the X component of the flow velocity becomes dominant, and the Z component of the flow velocity becomes sufficiently smaller than the X component of the flow velocity. Although the Z component of the flow velocity appears on the −X side of the center of the vortex, the direction is toward the X axis, and thus the microparticles do not flow toward the second outflow sections 26 side against the flow. The Z component of the flow velocity appears on the +X side of the centers of the vortices but is sufficiently smaller than the X component of the flow velocity.

In the present embodiment, the pair of second outflow sections 26 are arranged side by side in the Z direction with the inflow section 24 interposed therebetween, and are provided at positions that are point symmetrical with respect to the X axis. Therefore, the flow velocity distribution in the region on the +Z side with respect to the X axis and the flow velocity distribution in the region on the −Z side with respect to the X axis have symmetrical shapes, and the power balance between the two is balanced. Therefore, it is possible to suppress the disturbance of the vortex shape due to the difference between the flow velocity distribution on the +Z side and the flow velocity distribution on the −Z side and the increase in the Z component of the flow velocity.

Note that although not shown, the fluidic device 10 of the present embodiment generates vortices that are symmetrical in the XY plane centered on the X axis.

However, since the second outflow sections 26 are not provided on either of the +Y sides of the inflow section 24, even if microparticles are contained in the fluid dispersed in the Y direction, they do not flow out from the second outflow sections 26. Since the Y component of the flow velocity is distributed toward the X axis on the +X side of the trapping section 21S, even when the fluid dispersed in the Y direction contains microparticles, they are moved to the X axis by the flow of the fluid.

On the other hand, in the comparative example shown in FIG. 9, microparticles can be trapped at the positions of the respective nodes of the standing wave, and many microparticles would be trapped at the nodes on the −Z side where the inflow section 92 is disposed. These microparticles are caused to flow to the +X side by the flow of the fluid and could flow out from the first outflow section 93.

However, in the fluidic device 90 of the comparative example, the second outflow section 94 is also provided on the +X side of the trapping section 91S. Therefore, as shown in FIG. 9, the fluid flowing toward the second outflow section 94 also increases, and the center of the vortex is generated in the vicinity of the corner portion on the −X side and the +Z side of the trapping section 91S. In the fluidic device 90 of the comparative example, in addition the X component of the flow velocity from the inflow section 92 toward the first outflow section 93, the Z component of the flow velocity also increases. That is, in the fluidic device 90 of the comparative example, since a large Z component of the flow velocity is generated in the Z direction in which the acoustic radiation force of the standing wave acts, the number of microparticles moving in the Z direction against the acoustic radiation force increases.

Whether or not the microparticles can be efficiently trapped at the positions of the nodes of the standing wave SW is determined by the acoustic radiation force Fs of the standing wave SW and the viscous force Fu of the fluid. The acoustic radiation force Fs is expressed by the following formula (1), and the fluid viscous force Fu is expressed by the following formula (2).

$$Fs = V ( B + 1 ) k \frac{{P}^{2}}{{ρ}_{0} {c}_{n}} sin ( 2 kz ) \qquad ( 1 )$$

$$Fu = - 6 π η aZ \qquad ( 2 )$$

Here, V is the volume of the fluid (volume of the trapping section 21S), P is the acoustic pressure of the ultrasonic waves, Po is the concentration of the fluid, Cn is the speed of sound in the fluid, k is the wave number of the ultrasonic waves (reciprocal of the wavelengths of the ultrasonic waves A), z is the position coordinates in the Z direction, Z is the Z component of the flow velocity, n is the viscosity of the fluid, and a is the diameter of the microparticle. In addition, B=3 (ρ−ρ₀)/(2ρ+ρ0), wherein p represents the density of the microparticles.

The allowable value |Z| of the Z component of the flow velocity at which the microparticles do not move in the Z direction with respect to the acoustic pressure P of the ultrasonic wave applied by the ultrasonic applying section 30 is expressed by the following formula (3).

$$\vert Z \vert = \vert \frac{V ( B + 1 ) k \frac{P}{{ρ}_{0} {c}_{n}}}{6 π η a} \vert {P}^{2} \qquad ( 3 )$$

For example, when P=550 kPa, |Z| is approximately 0.01 m/s. By setting the Z component of the flow velocity of the fluid to less than 0.01 m/s, the microparticles can be converged at the positions of the nodes by the acoustic radiation force of the standing wave SW, and the movement in the Z direction by the flow velocity of the fluid can be suppressed.

In the comparative example shown in FIG. 9, as described above, the fluid that flowed into the trapping section 91S from the inflow section 92 flows toward not only the first outflow section 93 but also toward the second outflow section 94, and the Z component of the flow velocity increases. In this case, at a lower flow rate, the Z component of the flow velocity may exceed 0.01 m/s, the microparticles flow in the Z direction against the acoustic radiation force of the standing wave, and the capture rate of the microparticles by the standing wave decreases. Therefore, in order to increase the trapping efficiency of the microparticles, it is necessary to couple other fluidic devices 90 to the second outflow section 94, which increases the size of the apparatus. Alternatively, the driving voltage of the ultrasonic applying section 95 may be increased to increase the acoustic radiation force, but in this case, there is a problem of an increase in power consumption.

On the other hand, in the present embodiment, as shown in FIGS. 7 and 8, the Z component of the flow velocity is approximately 0.005 m/s at the maximum, and it can be confirmed that the Z component of the flow velocity is less than the allowable value |Z| of the Z component of the flow velocity at which the microparticles do not move in the Z direction. In addition, because the X component of the flow velocity is sufficiently larger than the Z component of the flow velocity, the microparticles can be moved to the +X side in a state where they are trapped at the position of the node of the standing wave SW. Therefore, in the fluidic device 10 of the present embodiment, a concentrated fluid having a high microparticle concentration can flow out from the first outflow section 25 with the single fluidic device 10 and with the smaller driving electric power.

Note that in FIG. 7, a portion where the Z component of the flow velocity has a negative value is a flow toward the X axis (center), and therefore, is not a problem. In FIG. 8, the X component of the flow velocity at the position of x=0 is low because the flow velocity at the boundary position between the inflow section 24 and the wall surface of the negative side wall section 22 is shown.

### Operational Effects of Present Embodiment

The fluidic device 10 of the present embodiment includes the body 20 having a flow path through which fluid flows, and an ultrasonic applying section 30 which is provided on a flow path wall forming the flow path of the body 20, transmits an ultrasonic wave in the Z direction, and forms the standing wave SW in the flow path. The body 20 has the inflow section 24 for allowing fluid to flow into the trapping section 21S along the X direction, the first outflow section 25 for allowing concentrated fluid containing a large amount of microparticles captured by the standing wave SW to flow out, and the second outflow sections 26 for allowing diluted fluid having a lower concentration of microparticles than the first fluid to flow out from the trapping section 21S, with the portion where the ultrasonic applying section 30 is disposed as the trapping section 21S. The inflow section 24 is provided in the negative side wall section 22 on the −X side of the trapping section 21S, the first outflow section 25 is provided in the positive side wall section 23 on the +X side of the trapping section 21S, and the second outflow sections 26 are provided at positions different from the inflow section 24 in the negative side wall section 22.

With such a configuration, the fluid that has flowed into the trapping section 21S from the inflow section 24 forms a vortex due to the rapidly expanding flow path widths and has flow velocity components not only in the X direction but also in the Z direction. However, in the present embodiment, since only the first outflow section 25 is provided on the +X side and the second outflow sections 26 are provided on the −X side, the X component of the flow velocity toward the first outflow section 25 is dominant in the flow velocity at a position along the X axis of the fluid flowing into the trapping section 21S from the inflow section 24, and the Z component of the flow velocity becomes sufficiently small. Therefore, it is possible to suppress the disadvantage that the microparticles move in the Z direction against the acoustic radiation force of the standing wave SW. Therefore, for example, it is possible to cause the concentrated fluid having a high concentration to flow out from the first outflow section 25 without connecting a plurality of fluidic devices 10 or increasing the driving voltage in the ultrasonic applying section 30.

In the present embodiment, the first outflow section 25 is provided at a position facing the inflow section 24 with the trapping section 21S interposed therebetween. That is, the inflow section 24 and the first outflow section 25 are each provided along the X axis. As a result, the fluid flows from the inflow section 24 toward the first outflow section 25 along the X axis, and an increase in the flow velocity component in the Z direction can be suppressed.

In the present embodiment, the bore diameter W2 of the first outflow section 25 is larger than the bore diameter W1 of the inflow section 24. If the bore diameter W2 of the first outflow section 25 were smaller than the bore diameter W1 of the inflow section 24, the amount of the fluid flowing out from the first outflow section 25 would decrease. In this case, there is a risk that the microparticles that did not flow out from the first outflow section 25 would move in the Z direction and then flow out from the second outflow sections 26. On the other hand, in the present embodiment, since the bore diameter W2 of the first outflow section 25 is sufficiently large, the microparticles trapped (converged) at the positions of the nodes of the standing wave SW are caused to flow in the X axis direction as they are, whereby the concentrated fluid having a high microparticle concentration can be caused to flow out from the first outflow section 25.

In the present embodiment, the bore diameter W3 of the second outflow sections 26 is larger than the bore diameter W1 of the inflow section 24. Therefore, the amount of the fluid flowing out from the second outflow sections 26 can be increased, and the diluted fluid can flow out appropriately. That is, if the bore diameter W3 of the second outflow sections 26 were smaller than the bore diameter W1 of the inflow section 24, then the fluid that cannot flow out from the second outflow sections 26 would flow out from the first outflow section 25, and the concentration of the microparticles of the concentrated fluid would decrease. If the flow velocity in the vicinity of the second outflow sections 26 increases, then flow from the vicinity of the inflow section 24 directly toward the second outflow sections 26 is generated, and the Z component of the flow velocity increases. On the other hand, in the present embodiment, it is possible to cause the fluid to appropriately flow out from the second outflow sections 26 by the above-described configuration. The flow velocity in the vicinity of the second outflow sections 26 is not significantly increased, and an increase in the Z component of the flow velocity is also suppressed, thereby improving the efficiency of trapping microparticles.

The bore diameter W3 of the second outflow sections 26 is larger than the bore diameter W2 of the first outflow section 25.

If the relationship between the bore diameter W2 of the first outflow section 25 and the bore diameter W3 of the second outflow sections 26 were W2>W3, the amount of fluid flowing out from the second outflow sections 26 would decrease, and the amount of fluid flowing out from the first outflow section 25 would increase. Therefore, the concentration the microparticles in the concentrated fluid flowing out from the first outflow section 25 would be lower than that in the case of W2<W3. On the other hand, by setting W2<W3, it is possible to suppress the disadvantage that the concentration in the concentrated fluid becomes low.

In the present embodiment, the pair of second outflow sections 26 are provided at positions symmetrical with respect to the inflow section 24 on the negative side of the trapping section 21S in the X direction. More specifically, the pair of second outflow sections 26 are arranged side by side in the Z direction, and are provided at positions that are point symmetrical with respect to the X axis in the YZ plane.

Accordingly, the flow of fluid can be symmetrical in the region on the +Z side and the region on the −Z side of the trapping section 21S. That is, since the position and the flow path distribution of the vortices formed by the flow of the fluid are substantially the same, the flow velocity is balanced between the +Z side and the −Z side, and it is possible to suppress the disadvantage that the Z component of the flow velocity increases.

In the present embodiment, the ultrasonic applying section 30 forms the standing wave SW in which the position of the node overlaps with the first outflow section 25 when the trapping section 21S is viewed along the X direction.

That is, in the present embodiment, the position of the node of the standing wave SW is provided on the X-axis, and the center of the first outflow section 25 is provided on the X axis.

As described above, in the present embodiment, the X component of the flow velocity along the X axis is large, and the microparticles trapped at the positions of the nodes of the standing wave SW can be swept away to the first outflow section 25 by the flow velocity and caused to flow out. Thus, a concentrated fluid having a high concentration of microparticles can flow out from the first outflow section 25.

### Second Embodiment

Next, a second embodiment will be described.

The first embodiment is the example in which the ultrasonic applying section 30 is disposed on the +Z side of the trapping section 21S to form the standing wave SW in the Z direction. In this case, the acoustic radiation force of the standing wave SW acts so that microparticles converge on the XY plane passing through the X axis, and microparticles are prevented from moving in the Z direction against the acoustic radiation force. On the other hand, no acoustic radiation force acts in the Y direction. For this reason, if the microparticles are diffused in the Y direction, the microparticles that accumulate in the trapping section 21S increase, and the concentration of the microparticles caused to flow out from the first outflow section 25 decreases. Note that since the X component of the flow velocity along the X axis is sufficiently large, few microparticles diffuse in the Y direction, and even if the microparticles diffuse in the Y direction, they move to return to the X axis as described in the first embodiment. Therefore, the outflow of microparticles from the second outflow sections 26 is suppressed.

The second embodiment is different from the first embodiment in that a standing wave is also formed in the Y direction.

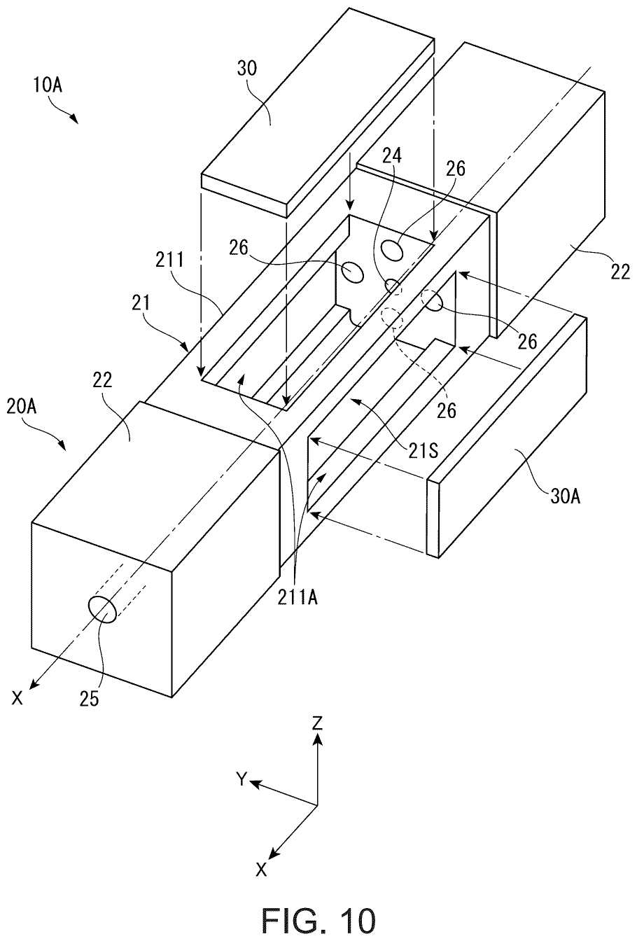

FIG. 10 is a perspective view showing a fluidic device 10A of the second embodiment.

In FIG. 10, the position of the first outflow section 25 is hidden by the positive side wall section 23, but is the same as that in the first embodiment. It is provided at a position facing the inflow section 24 on the X axis and is coupled to the trapping section 21S.

In the present embodiment, as shown in FIG. 10, the negative side wall section 22 is provided with four second outflow sections 26 on the outer periphery of the inflow section 24. Two of the four second outflow sections 26 are the same as those in the first embodiment, are arranged in the Z direction, and have the same distance from the X axis. That is, two of the four second outflow sections 26 are arranged in the Z direction and are provided at positions which are point symmetrical with respect to the X axis (inflow section 24). On the other hand, the other two second outflow sections 26 of the four second outflow sections 26 are arranged in the Y direction and are provided at positions which are point symmetrical with respect to the X axis (inflow section 24). That is, the four second outflow sections 26 are provided in rotational symmetry about the X axis (inflow section 24).

Further, in the present embodiment, in addition to the ultrasonic applying section 30 that forms the standing wave SW in the Z direction, a second ultrasonic applying section 30A (second ultrasonic element) that transmits ultrasonic waves along the Y direction and forms a standing wave in the Y direction is provided. The second ultrasonic applying section 30A is provided on one (−Y side in FIG. 10) of the opening sections 211A that face each other in the Y direction in the center section 21 of the body 20. Note that in the specific configuration of the second ultrasonic applying section 30A is the same as that of the ultrasonic applying section 30.

In such a fluidic device 10A, they are converged and trapped in the trapping section 21S at the intersection of the node of the standing wave formed in the Z direction and the node of the standing wave formed in the Y direction. When each standing wave is a first order standing wave, the intersection of each node coincides with the X axis, so that the microparticles converge and are trapped along the X axis.

Therefore, in the present embodiment, since the dispersion of the microparticles in the Y direction is suppressed, retention of microparticles in the trapping section 21S is suppressed, and it is possible to cause the concentrated fluid having a higher concentration of microparticles to flow out from the first outflow section 25.

### Operational Effects of Present Embodiment

The fluidic device 10A of the present embodiment further includes the second ultrasonic applying section 30A that transmits ultrasonic waves along the Y direction of the trapping section 21S of the body 20A and forms a standing wave along the Y direction. The second outflow sections 26 are respectively provided at positions rotationally symmetric with respect to the inflow section 24 in the negative side wall section 22 of the trapping section 21S.

Thus, in the present embodiment, the microparticles contained in the fluid flowing in from the inflow section 24 can converge and be captured on the X axis. That is, since microparticles are not dispersed not only in the Z direction but also not in the Y direction, the microparticles flowing in from the inflow section 24 can be more efficiently transported to the first outflow section 25, which is on the X axis, and the concentration of the microparticles in the concentrated fluid flowing out from the first outflow section 25 can be further increased.

### Modification

The present disclosure is not limited to the above-described embodiments, and configurations obtained by modifications, improvements, appropriate combinations of the embodiments, and the like within a range in which the object of the present disclosure can be achieved are included in the present disclosure.

### First Modification

In the first embodiment and the second embodiment, the configuration in which the plurality of second outflow sections 26 are provided is exemplified, but the disclosure is not limited thereto.

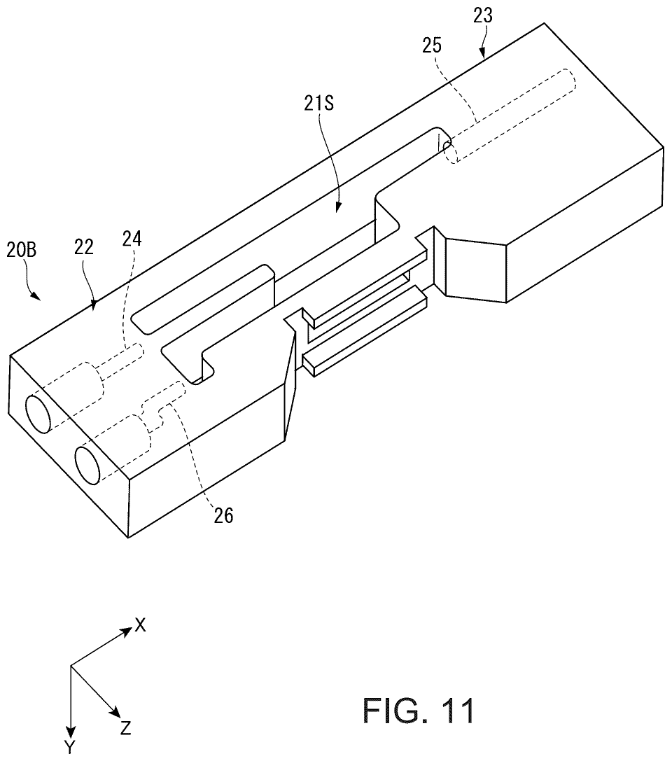

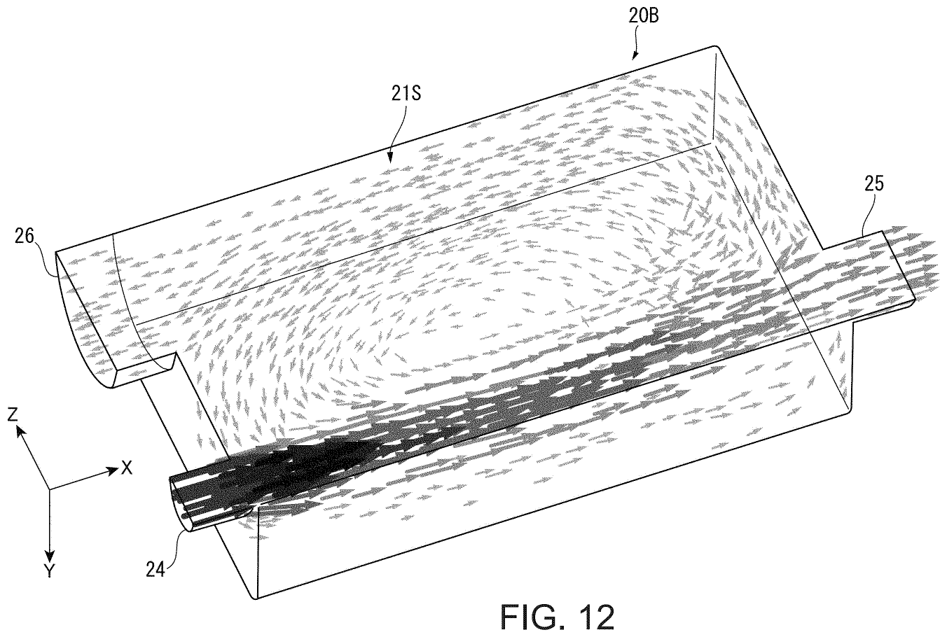

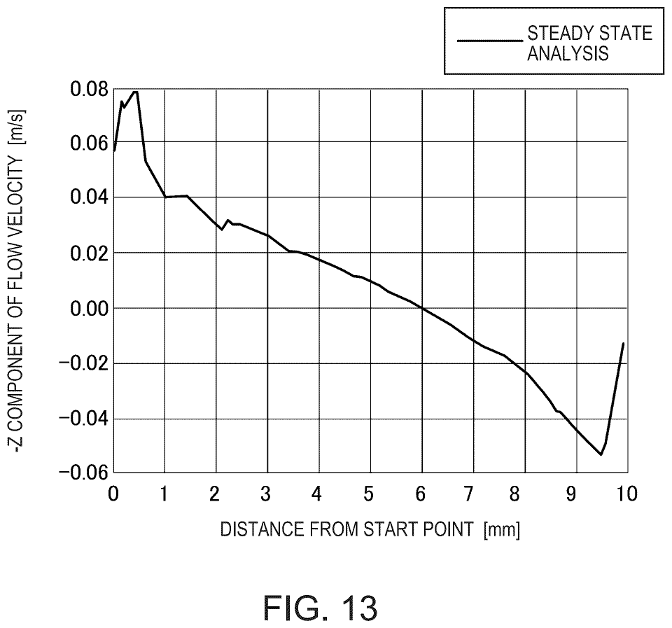

FIG. 11 is a perspective view showing a schematic configuration of a body 20B of a fluidic device according to the first modification, and FIG. 12 is a view showing a distribution of a flow velocity and direction of fluid when the fluid is caused to flow into the body 20B of the fluidic device. FIG. 13 shows the Z component of the flow velocity at the position where the inflow section 24 of the fluidic device extends in the X direction.

As in the first embodiment and the second embodiment, the body 20B of the fluidic devices according to the first modification includes the center section 21, the negative side wall section 22, and the positive side wall section 23. The ultrasonic applying section 30 and the flow path wall section 40, not shown, are fixed to the center section 21, thereby forming the trapping section 21S. Note that in FIG. 13, the ultrasonic applying section 30 and the flow path wall section 40 are not shown.

In the fluidic device according to the first modification, one second outflow section 26 coupled to the trapping section 21S is provided in the negative side wall section 22. To be specific, when ultrasonic waves are transmitted to the trapping section 21S in the Z direction by the ultrasonic applying section 30 to form a standing wave, the second outflow section 26 is disposed on the +Z side (or −Z side) of the inflow section 24 in the negative side wall section 22.

When the number of the second outflow sections 26 is one, the inflow section 24 is preferably provided at an end portion of the negative side wall section 22 in the Z direction in view of the balance of the flow velocity distribution of the fluid flowing through the trapping section 21S. In FIG. 11, for example, the inflow section 24 is provided on the −Z side of the negative side wall section 22. Accordingly, the first outflow section 25 is at a position facing the inflow section 24 across the trapping section 21S. It is preferably provided at a position on the −Z side of the positive side wall section 23.

As the standing wave formed by the ultrasonic applying section 30, a second or higher order standing wave is formed. In the standing wave of the primary mode, the position of the node is the center of the trapping section 21S in the Z direction, and it is not facing the first outflow section 25 (a position shifted from the center). In this case, some of the microparticles trapped at the positions of the nodes of the standing wave may move to the +Z side. On the other hand, a second or higher order standing wave is formed so that at least one node is formed at a position overlapping with the first outflow section 25 when viewed from the X direction.

Accordingly, as shown in FIGS. 12 and 13, it is possible to move the microparticles to the +X side by the flow of the fluid and cause the microparticles to flow out from the first outflow section 25.

Note that in the present example, the body 20B having the inflow section 24 at the −Z side end portion of the trapping section 21S, the first outflow section 25 at the −Z side end portion of the trapping section 21S, and the second outflow sections 26 at the +Z side end portion of the trapping section 21S is exemplified. However, the positions of the inflow section 24, the first outflow section 25, and the second outflow sections 26 may be moved toward the center of the trapping section 21S in the Z direction. However, in this case, there is a risk that the flow path distribution in the trapping section 21S, that is, the distribution of the Z component of the flow velocity, may be complicated. Therefore, as in the first modification, in a case where only one second outflow section 26 is provided, it is desirable that the inflow section 24 and the first outflow section 25 are provided at the −Z side end portion, and the second outflow sections 26 is provided at the +Z side end portion.

In the fluidic device of the first modification example, since only one second outflow section 26 is provided, the number of tubes coupled to the fluidic device can be reduced as compared with the first embodiment and the second embodiment. That is, for example, in a case where the fluidic device is integrated into a microparticle collection apparatus that collects microparticles from a fluid, a tube that allows the fluid to flow through each of the inflow section 24, the first outflow section 25, and the second outflow sections 26 is required. Therefore, when the number of coupled tubes in the microparticle collection apparatus increases, the configuration becomes complicated and the size of the apparatus accordingly increases. On the other hand, in the fluidic device of the first modification example, since the number of the second outflow sections 26 is small, the configuration of the microparticle collection device can be simplified and miniaturized.

### Second Modification

In the first embodiment, an example of the body 20 is shown in FIG. 2. However, as long as the positions of the inflow section 24, the first outflow section 25, and the second outflow sections 26 with respect to the trapping section 21S are the same, the flow path shapes of the inflow section 24 and the second outflow sections 26 in the negative side wall section 22 and the flow path shape of the first outflow section 25 in the positive side wall section 23 are not particularly limited.

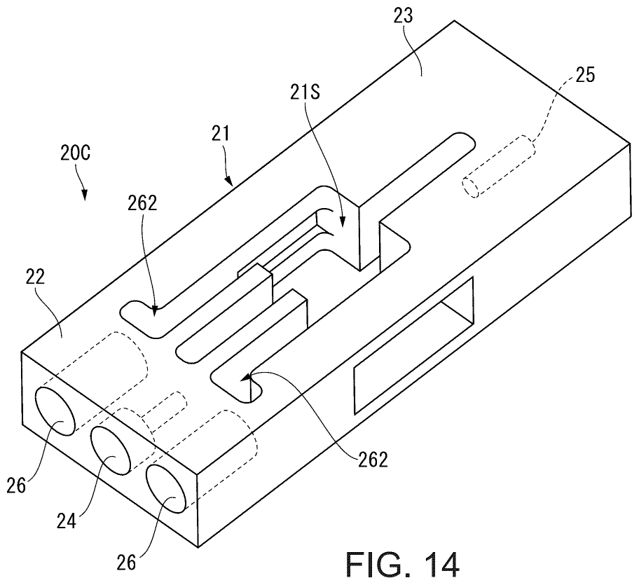

FIGS. 14 to 16 are perspective views showing examples of bodies 20C, 20D, and 20E of fluidic devices according to a second modification.

For example, in the body 20C shown in FIG. 14, the second outflow sections 26 on the +Z side extends in the negative side wall section 22 parallel to the X-axis along the −X side from the trapping section 21S, has a bending section 262 bent from the distal end (−X side end portion) to the +Z side, and has a flow path shape extending from the bending section 262 to the −X side end surface of the negative side wall section 22. Similarly, the second outflow section 26 on the −Z side has a bending section 262 bent to the −Z side, and further has a flow path shape extending from the bending section 262 to the −X side end surface of the negative side wall section 22.

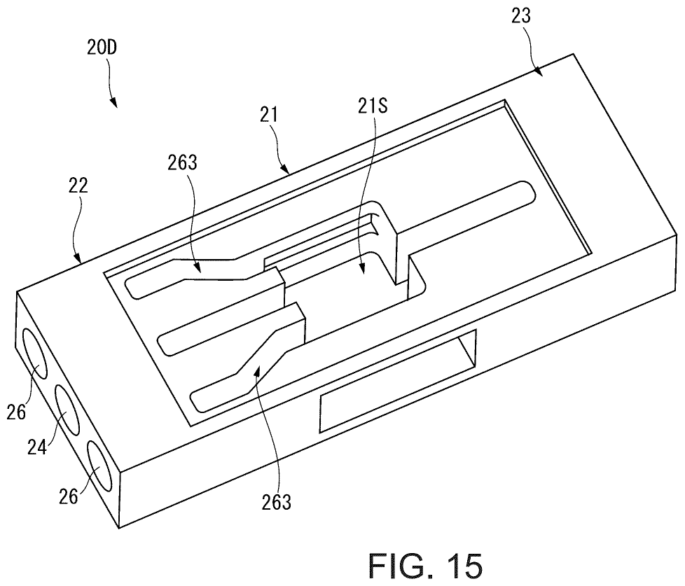

In the body 20D shown in FIG. 15, the second outflow section 26 on the +Z side has an inclined section 263 which is inclined to the +Z side as being separated from the trapping section 21S in the negative side wall section 22, and further has a flow path shape which extends from the inclined section 263 to the −X side end surface of the negative side wall section 22. Similarly, the second outflow sections 26 on the −Z side has an inclined section 263, which inclines to the −Z side as the distance from the trapping section 21S increases. The flow path shape extends from the inclined section 263 to the −X side end surface of the negative side wall section 22.

Because the distances between the inflow coupling section 241 corresponding to the inflow section 24 and the second outflow coupling section 261 can be increased in the bodies 20C and 20D, the coupling work can be reduced when the inflow tube and the second outflow tube are coupled to the bodies 20C and 20D.

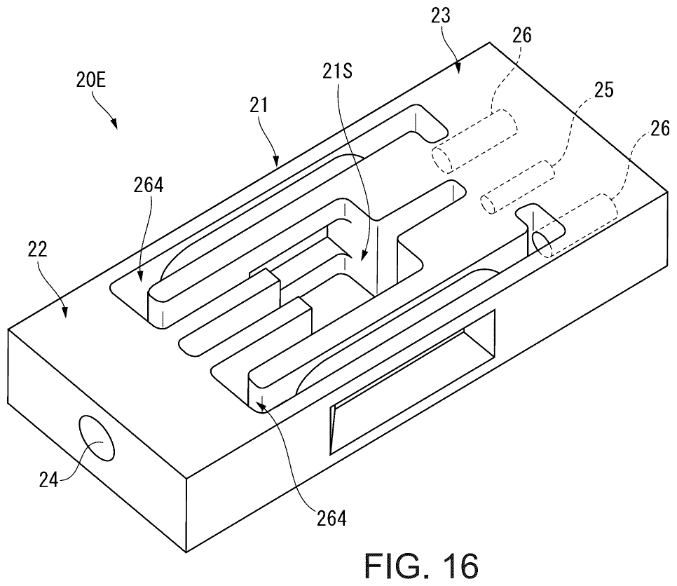

In the body 20E shown in FIG. 16, the second outflow sections 26 on the +Z side extends from the trapping section 21S to the −X side in the negative side wall section 22, and has a turnback section 264 that turns back toward the +Z side and the +X side at the distal end thereof, and the second outflow sections 26 extends to the +X side end surface of the positive side wall section 23 by the turnback section 264. Similarly, the second outflow sections 26 on the −Z side extends to the +X side end surface of the positive side wall section 23 via the turnback section 264. Accordingly, the first outflow coupling section 251 of the first outflow section 25 and the second outflow coupling section 261 of the second outflow sections 26 are provided on the +X side of the body 20E.

Therefore, in the fluidic device using the body 20E of the present modification, the inflow tube through which the fluid is introduced can be coupled to the −X side end surface, and the first outflow tube and the second outflow tube through which the concentrated fluid and the diluted fluid flow out can be coupled to the +X side end surface. That is, the outflow coupling ports from which the fluid flows out of the fluidic device can be located in the same direction.

### Third Modification

In the first embodiment, an example in which the trapping section 21S has a rectangular shape in a cross-sectional view in the YZ plane has been described, but the present disclosure is not limited thereto. For example, the flow path wall section 40 on the +Y side may have a curved shape instead of a flat shape. The +Y side flow path wall section 40 may be formed of a material having a low reflection efficiency of ultrasonic waves or a sound absorbing property.

In the second embodiment, an example is shown in which the cross section of the trapping section 21S in the YZ plane has a rectangular shape to form a standing wave in the Y direction and the Z direction. However, for example, the cross section may have a polygonal shape such as a hexagonal shape, and a standing wave may be formed by each combination of a pair of surfaces facing and parallel to each other with the trapping section 21S interposed therebetween. For example, in the case of a hexagonal cross sectional shape, a standing wave may be formed along each axis orthogonal to the X axis at an interval of 120 degrees.

### Fourth Modification

In the first embodiment and the second embodiment, an example in which the standing wave of the first order mode is formed has been described. However, as described above, a high order standing wave may be formed as long as the standing wave has one or more nodes overlapping at a position overlapping the first outflow section 25 when viewed from the X direction.

### Fifth Modification

In the first embodiment, an example in which the bore diameters W1, W2, and W3 of the inflow section 24, the first outflow section 25, and the second outflow sections 26 have a relationship of W1<W2<W3 has been described, but the present disclosure is not limited thereto.

For example, if the total cross sectional area of the second outflow sections 26 is larger than that of the first outflow section 25, W2 may be W2=W3 or W2>W3.

### SUMMARY OF PRESENT DISCLOSURE

In the first aspect according to the present disclosure, a fluidic device that uses ultrasonic waves to trap microparticles contained in a fluid, the fluidic device includes: a body having a flow path through which the fluid flows and an ultrasonic element provided on a flow path wall forming the flow path of the body and configured to transmit ultrasonic waves in a first direction to form a standing wave in the flow path, wherein the body has, with a portion where the ultrasonic element is arranged as a trapping section, an inflow section configured to cause the fluid to flow into the trapping section along a second direction, which intersects the first direction, a first outflow section through which concentrated fluid containing microparticles trapped by the standing wave flows out from the trapping section, and a second outflow section through which diluted fluid having a concentration of the microparticles lower than that of the concentrated fluid flows out from the trapping section, the inflow section is provided at a negative side of the trapping section in the second direction, the first outflow section is provided at a positive side of the trapping section in the second direction, and the second outflow section is provided at the negative side of the trapping section in the second direction at a position different from that of the inflow section.

In such a fluidic device, a vortex is formed in the fluid flowing from the inflow section into the trapping section due of the width of the rapidly widened flow path width. Therefore, it has a flow velocity component not only in the X direction but also in the Z direction. However, in this aspect, only the first outflow section is provided on the positive side in the second direction, and the second outflow section is provided on the negative side. Therefore, the component of the flow velocity of the fluid flowing from the inflow section into the trapping section in the second direction toward the first outflow section is dominant on the axis of the inflow section, and the component of the flow velocity in the first direction can be sufficiently reduced. Therefore, it is possible to suppress a disadvantage that the microparticles move in the first direction against the acoustic radiation force of the standing wave. Therefore, for example, it is possible to cause a concentrated fluid having a high concentration to flow out from the first outflow section without coupling a plurality of fluidic devices or increasing the driving voltage of the ultrasonic element. That is, it is possible to provide a low cost and small sized fluidic device having a high trapping efficiency of microparticles.

In the fluidic device of this aspect, it is desirable that the first outflow section is provided at a position facing the inflow section with the trapping section interposed therebetween.

Thus, the microparticles contained in the fluid flowing in from the inflow section can be trapped by the nodes of the standing wave formed coaxially with the inflow section. As described above, since the flow velocity component in the first direction is dominant on the axis of the inflow section, the microparticles captured at the position of the node of the standing wave can be moved to the first outflow section by the flow of the fluid, and the concentrated fluid having a high concentration can be made to flow out from the first outflow section 25.

In the fluidic device of this aspect, the bore diameter of the first outflow section is desirably larger than the bore diameter of the inflow section.

If the bore diameter of the first outflow section is smaller than the bore diameter of the inflow section, the amount of the fluid flowing out from the first outflow section decreases. In this case, the microparticles that did not flowed out from the first outflow section are at risk of moving in the first direction and then flowing out from the second outflow section. On the other hand, in this aspect, because the bore diameter of the first outflow section is sufficiently large, it is possible to cause the concentrated fluid having a high microparticle concentration to flow out from the first outflow section by causing the microparticles trapped at the position of the node of the standing wave to flow in the second direction as they are.

In the fluidic device of the present aspect, the bore diameter of the second outflow section is desirably larger than the bore diameter of the inflow section.

If the bore diameter of the second outflow section is smaller than the bore diameter of the inflow section, the fluid that cannot flow out from the second outflow section flows out from the first outflow section, and thus the concentration of the microparticles in the concentrated fluid decreases. When the flow velocity in the vicinity of the second outflow section increases, a flow directly from the vicinity of the inflow section to the second outflow section is generated, and the Z component of the flow velocity increases. In contrast, in this aspect, it is possible to cause the fluid to appropriately flow out from the second outflow section. The flow velocity in the vicinity of the second outflow section is not significantly increased, and an increase in the flow velocity component in the first direction is also suppressed. Thus, the efficiency of trapping microparticles can be improved.

In the fluidic device of this aspect, the bore diameter of the second outflow section is desirably larger than the bore diameter of the first outflow section.

If the bore diameter of the first outflow section 25 is larger than the bore diameter of the second outflow sections 26, the outflow amount of the fluid from the second outflow section decreases, and the outflow amount of the fluid from the first outflow section increases. Therefore, the concentration of the microparticles in the concentrated fluid flowing out from the first outflow section decreases. On the other hand, in this aspect, it is possible to suppress a decrease in concentration of the concentrated fluid.

In the fluidic device of the present aspect, the inflow section is desirably provided at the center of the trapping section when the trapping section is viewed along the second direction.

Accordingly, the flow velocity distribution of the fluid flowing in from the inflow section is symmetrical with respect to the axial center (the axis parallel to the second direction) of the inflow section. Therefore, the stresses acting on the microparticles due to the flow velocity are balanced, and an increase in the flow velocity component in the first direction can be suppressed.

In the fluidic device of the present aspect, it is desirable that a plurality of the second outflow sections is provided, and the second outflow sections are provided at positions symmetrical with respect to the inflow section on the negative side of the trapping section in the second direction.

Thus, as in the above-described aspect, the flow velocity distribution of the fluid caused to flow in from the inflow section can be made symmetrical with respect to the axial center of the inflow section (the axis parallel to the second direction), the stress acting on the microparticles due to the flow velocity is balanced, and an increase in the flow velocity component in the first direction can be suppressed.

In the fluidic device of the present aspect, the second outflow sections are provided at positions that are point symmetrical with respect to the center of the inflow section along the first direction.

In this aspect, the second outflow sections are point symmetric along the first direction in which the standing wave is formed by the ultrasonic applying section. Therefore, the flow velocity distribution of the fluid in the first direction can be made symmetrical with respect to the axial center (axis parallel to the second direction) of the inflow section, and an increase in the flow velocity component in the first direction can be suppressed.

The fluidic device of this aspect includes a second ultrasonic element that is provided on the flow path wall forming the flow path of the body, transmits an ultrasonic wave along a third direction orthogonal to the first direction and the second direction of the trapping section, and forms a standing wave along the third direction. The second outflow section is provided at rotationally symmetric positions with respect to the inflow section on the negative side of the trapping section. fluidic device of this aspect includes a second ultrasonic element that is provided on the flow path wall forming the flow path of the body, transmits an ultrasonic wave along a third direction orthogonal to the first direction and the second direction of the trapping section, and forms a standing wave along the third direction, and the second outflow sections are respectively provided at positions rotationally symmetric with respect to the inflow section on the negative side of the trapping section.

In this aspect, by forming the standing waves along the first direction and the third direction, it is possible to trap the microparticles on the central axis of the trapping section, that is, the axial center of the inflow section where the nodes of the standing waves overlap each other. Therefore, the movement of the microparticles in the first direction and the third direction is restricted even when the second outflow sections sandwiching the inflow section are provided not only at the position along the first direction of the inflow section but also at the position along the third direction of the inflow section. Thus, a concentrated fluid having a higher concentration can be caused to flow out from the first outflow section.

In the fluidic device of the present aspect, it is desirable that the ultrasonic element forms the standing wave in which the position of a node overlaps with the first outflow section when the trapping section is viewed along the second direction.

In this aspect, the component of the flow velocity along the second direction is large, and the microparticles trapped at the position of the node of the standing wave can be swept away and caused to flow out to the first outflow section by the flow velocity. Accordingly, a concentrated fluid having a high concentration of microparticles can be caused to flow out from the first outflow section.

What is claimed is:

1. A fluidic device that uses ultrasonic waves to trap microparticles contained in a fluid, the fluidic device comprising:
a body including a flow path through which the fluid flows and
an ultrasonic element provided on a flow path wall forming the flow path of the body and configured to transmit ultrasonic waves in a first direction to form a standing wave in the flow path, wherein
the body includes, with a portion where the ultrasonic element is arranged as a trapping section,
an inflow section configured to cause the fluid to flow into the trapping section along a second direction, which intersects the first direction,
a first outflow section through which concentrated fluid containing microparticles trapped by the standing wave flows out from the trapping section, and
a second outflow section through which diluted fluid having a concentration of the microparticles lower than that of the concentrated fluid flows out from the trapping section,
the inflow section is provided at a negative side of the trapping section in the second direction,
the first outflow section is provided at a positive side of the trapping section in the second direction, and
the second outflow section is provided at the negative side of the trapping section in the second direction at a position different from that of the inflow section.

2. The fluidic device according to claim 1, wherein
the first outflow section is at a position facing the inflow section with the trapping section interposed therebetween.

3. The fluidic device according to claim 1, wherein
a bore diameter of the first outflow section is larger than a bore diameter of the inflow section.

4. The fluidic device according to claim 1, wherein
a bore diameter of the second outflow section is larger than a bore diameter of the inflow section.

5. The fluidic device according to claim 1, wherein
the bore diameter of the second outflow section is larger than the bore diameter of the first outflow section.

6. The fluidic device according to claim 1, wherein
the inflow section is at a center of the trapping section when the trapping section is viewed along the second direction.

7. The fluidic device according to claim 1, wherein
a plurality of second outflow sections is provided at symmetrical positions with respect to the inflow section on the negative side of the trapping section in the second direction.

8. The fluidic device according to claim 7, wherein
the second outflow sections at positions that are point-symmetrical with respect to the center of the inflow section along the first direction.

9. The fluidic device according to claim 7, further comprising:
a second ultrasonic element located on the flow path wall forming the flow path of the body, transmits an ultrasonic wave along a third direction orthogonal to the first and second directions of the trapping section, and forms a standing wave along the third direction, wherein
the second outflow sections are at positions rotationally symmetric with respect to the inflow section on the negative side of the trapping section.

10. The fluidic device according to claim 1, wherein
the ultrasonic element forms the standing wave in which a position of a node overlaps with the first outflow section when the trapping section is viewed along the second direction.
